(19) United States
(12) Patent Application Publication
(10) Pub. No.: US 2023/0099406 A1
(43) Pub. Date: Mar. 30, 2023

(54) GUIDE VANE RING FOR A TURBOMACHINE, TURBOMACHINE AND METHOD FOR MOUNTING A GUIDE VANE RING

(71) Applicant: MTU Aero Engines AG, München (DE)

(72) Inventor: Werner Humhauser, Moosburg (DE)

(73) Assignee: MTU Aero Engines AG, München (DE)

(21) Appl. No.: 17/817,159

(22) Filed: Aug. 3, 2022

(30) Foreign Application Priority Data
Aug. 5, 2021 (DE) 10 2021 120 384.8

(51) Int. Cl. F01D 9/04; F01D 11/00; F01D 25/16

(52) U.S. Cl. CPC F01D 9/041; F01D 11/003; F01D 25/162; F01D 25/005; F05D 2220/323; F05D 2240/12

(57) ABSTRACT

The invention relates to a guide vane ring for a turbomachine comprising at least one guide vane, at least one bearing body, and at least two inner ring segments. The guide vane has a bearing journal that is arranged in a in form-fitting manner in a bearing bush of the at least one bearing body. The at least two inner ring segments have on their respective outer radial faces a guide channel running along a circumferential direction of the guide vane ring for receiving the bearing body, into which project at least two opposite-lying guide projections of the inner ring segments, said projections running along the circumferential direction of the guide vane ring. The bearing bodyis arranged in the guide channel of the inner ring segments, and the at least two guide projections of the inner ring segments engage in at least two guide grooves of the bearing body.

### BACKGROUND OF THE INVENTION

The invention relates to a guide vane ring for a turbomachine. Further aspects of the invention relate to a turbomachine comprising at least one guide vane ring, as well as a method for mounting a guide vane ring for a turbomachine.

The blading of a turbomachine comprises two types of blades, which differ from one another in their functions. Rotating blades are a part of the rotor and are provided for a conversion of power. The individual rotating blades are arranged here as a rotating blade ring on a shaft of the rotor. Guide vanes are arranged on a stator of the turbomachine. In this case, the individual guide vanes are arranged as a guide vane ring, which have an inner ring in addition to the guide vanes. This inner ring revolves around the shaft of the rotor and is provided for the purpose of stabilizing the individual guide vanes of the guide vane ring in a central point. The individual guide vanes are mounted in the inner ring by their radially inner ends. The inner ring is usually composed of inner ring segments in order to make possible an arrangement of the radially inner ends during mounting. The task of the guide vanes consists in influencing the flow in such a way that it impacts the rotating blades at a predetermined angle. In this case, guide vanes can be rotatably mounted, so that the angle at which the flow strikes the rotating blades can be varied.

In order to ensure a high efficiency in turbomachines, it is necessary to minimize flow leakage in the region of the inner ring. For this purpose, the inner ring segments of the inner ring comprise sealing devices. These are provided for the purpose of reducing flows in gaps between the inner ends of the guide vanes and the inner ring segments. In order to minimize flows in a region between the shaft and the inner ring, sealing means are arranged in this region. The efficiency losses due to leakages through the inner ring can be effectively reduced by sealing devices. Leakage flows between the inner ring and the shaft of the turbomachine can be limited by sealing means only conditionally. This is due to the fact that during the course of operation of the turbomachine, a change in the curvature of the inner ring can take place. In such a case, the curvature of the inner ring can be increased or decreased in regions. Based on the change in the curvature, the space between the inner ring and the shaft can increase or decrease in regions. With an increase in the space, increased leakage flows occur in this region, which reduces the efficiency of the turbomachine. If there is a reduction in the space, the sealing means in this region can grind against the shaft.

This change in the curvature is also referred to as cording. One possibility for reducing cording consists in increasing the number of inner ring segments of which the inner ring is composed. However, the problem arises here that the mechanical stability of the bearing of the inner ring can decrease through the guide vanes.

A guide vane ring of a gas turbine as well as a mounting method are disclosed in EP 2 696 041 A1. The guide vane ring is an adjustable guide vane ring of a turbomachine, whose guide vanes are each borne individually in a bearing body, on which an inner ring that is divided into two half rings and acts as a seal carrier is displaced in a deformation-free manner, when viewed in the peripheral direction. In this case, the guide vanes are borne by bearing bodies in the inner ring.

A guide vane ring of a gas turbine as well as a mounting method are disclosed in US 2014 0044526 A1. Each guide vane of the guide vane ring is borne in an individual bearing body having a bearing bore for guiding a bearing journal of the respective guide vane. The inner ring of the guide vane ring is composed of two half rings that are moved onto the bearing bodies in the peripheral direction. The bearing bodies are in contact laterally and have two corresponding guide grooves extending in the peripheral direction and opposite to one another. The half rings each have guide projections extending in the peripheral direction, which engage in the guide grooves of the bearing bodies.

US 9,605,549 B2 discloses a guide vane ring having a plurality of guide vanes, wherein each guide vane is borne in an individual bearing body, each one having a bearing bore for guidance of a bearing journal of the respective guide vane, and the inner ring is composed of two half rings which are displaced in the peripheral direction on the bearing bodies. The bearing bodies are in contact laterally and have two corresponding guide grooves extending in the peripheral direction and opposite to one another. The half rings each have guide projections that extend in the peripheral direction and engage in the guide grooves.

EP 3 315 728 A1 describes a guide vane ring which comprises at least one attenuating element that is arranged in an uptake channel between the bearing bodies and an inner ring for receiving bearing bodies.

A seal on the inner ring of a guide vane ring is disclosed in US 10,494,944 B2. The guide vane ring according to this invention comprises an inner ring on whose radially outer surface an uptake channel runs in the peripheral direction and a plurality of bearing bodies is arranged in this channel. The guide vane ring comprises a plurality of guide vanes, each of which is inserted by its radially inner end into one of the bearing bodies, and has at least one sealing element for sealing at least one gap between the inner ring and at least one of the bearing bodies and/or between two bearing bodies.

US 8,858,165 B2 discloses a variable guide vane arrangement for a gas turbine engine that comprises a guide vane that is pivotable about an axis of rotation. The guide vane comprises a flap section which can be positioned in a fluid flow in order to control the fluid flow.

US 6,210,106 B1 discloses a sealing device for sealing leakages around a journal assembly of a gas turbine engine with a variable blading that is rotatably supported by an engine housing.

US 2016 0376900 A1 discloses a stator device for a turbomachine having a housing device and a plurality of guide vanes.

### SUMMARY OF THE INVENTION

An object of the invention is to provide a solution that makes possible a stable bearing of the inner ring by way of guide vanes.

This object is achieved by a guide vane ring for a turbomachine, by a turbomachine, as well as by a method for mounting a turbomachine of the present invention. Advantageous embodiments with appropriate enhancements of the invention are discussed in detail below.

A first aspect of the invention relates to a guide vane ring for a turbomachine. The turbomachine may involve, in particular, a turbine for an aircraft. The guide vane ring has at least one guide vane, at least one bearing body, and at least two inner ring segments. The guide vane may involve a vane that can be set up for the purpose of guiding a flow of air in such a way that it strikes a rotating blade at a predetermined angle. The guide vane can be rotatably mounted in order to be able to variably change the angle of the flow. The bearing body is provided for the purpose of receiving the guide vanes and thus to make possible a bearing of the guide vanes in the at least two inner ring segments. The inner ring segments are provided for the purpose of mechanically stabilizing the radially inner ends of the guide vane and thus to make possible a stable operation of the guide vane ring.

The guide vane has a bearing journal that is arranged in a in form-fitting manner in a bearing bush of the at least one bearing body. In other words, the guide vane has a tapered section at one of its radially inner ends, which is provided for making possible a bearing of the guide vane in a bearing body. The bearing journal can be cylindrical, for example. The bearing journal of the guide vane in this case is arranged in the bearing bush of the bearing body. The bearing bush can be shaped, for example, complementary to the shape of the bearing journal.

The at least two inner ring segments have on the respective outer radial faces a guide channel running along a circumferential direction of the guide vane ring for receiving the bearing body, into which project at least two opposite-lying guide projections of the inner ring segments, said projections running along the circumferential direction of the guide vane ring. The at least two inner ring segments can form the inner ring of the guide vane ring. In other words, the inner ring segments comprise the guide channel, which runs along the circumferential direction of the guide vane ring around the inner ring, in order to make possible an arrangement of the guide vanes in the inner ring. In this case, the guide channel can be arranged on the respective outer radial faces of the inner ring. In other words, the guide channel is aligned in a face of the inner ring that is directed radially outward. The guide channel has at least two opposite-lying guide projections running along the circumferential direction of the guide vane ring. The guide projections are fitted in order to make possible a form-fitting bearing of the bearing body in the guide channel. The bearing body is arranged in the guide channel of the inner ring segments. The at least two guide projections of the inner ring segments engage in the at least two guide grooves of the bearing body. In other words, the bearing body is arranged in such a way in the guide channel that the two guide projections of the inner ring segments engage in the at least two guide grooves of the bearing body.

It is provided that the bearing journal of the guide vane has a journal groove, into which the guide projections of the inner ring segment engage. In other words, it is provided that the guide projections of the inner ring segments engage in both the guide grooves of the bearing body and in the journal groove of the bearing journal of the guide vane. The advantage results thereby that the bearing journal of the guide vane is directly connected to the inner ring segment. In this way, a more stable mechanical connection can be achieved between the guide vane and the inner ring segment than in conventional connections by way of the bearing body.

An enhancement of the invention provides that the journal groove runs around a lengthwise axis of the bearing journal. In other words, it is provided that the journal groove runs around the bearing journal. For example, it can be provided that the bearing journal is radially symmetric and has a recess running around the entire circumference of the bearing journal as the journal groove.

An enhancement of the invention provides that a journal groove radius of the bearing journal in a lengthwise region of the respective journal groove is at most half as large as a journal radius outside the journal groove. In other words, in the region of the journal groove, the bearing journal has a radius that is at most half as large as the radius of the bearing journal outside the journal groove.

An enhancement of the invention provides that the bearing journal has an inner guide vane plate and an outer guide vane plate, which are separated from each other by the journal groove. This enhancement provides the advantage that the two guide vane plates make possible a predetermined bearing of the bearing journal in the bearing body and the inner ring segment.

An enhancement of the invention provides that the bearing journal has a bore at an axial end of the bearing journal, said bore running parallel to the axis of the bearing journal and receiving a pin of the bearing body. In other words, a bore is found at one end of the bearing journal, and a pin of the bearing body is arranged in the bore. The enhancement provides the advantage that a centered arrangement of the bearing journal in the bearing bush of the bearing body is made possible.

An enhancement of the invention provides that the inner ring segments have a central point angle of 30 degrees, 45 degrees, 60 degrees, 90 degrees or 180 degrees. In other words, it is provided that the inner ring segments have a curvature, so that the inner ring is composed of 12, 8, 6, 4, or 2 inner ring segments. The enhancement provides the advantage that the inner ring is composed of a plurality of inner ring segments, whereby changes in curvature due to cording can be reduced.

An enhancement of the invention provides that the bearing body is composed, at least partially, of metal and/or a carbon. In other words, the bearing body comprises an alloy of metal and/or carbon.

An enhancement of the invention provides that sealing bodies are arranged on the inner radii of the inner ring segments. In other words, it is provided that the inner ring has sealing bodies on one side facing the shaft of a rotor, and these reduce the air flow in a region between the inner ring and the shaft. In this way, the advantage results that the efficiency of the turbomachine can be increased.

A second aspect of the invention relates to a turbomachine comprising at least one guide vane ring. In particular, the turbomachine may involve a turbomachine of an aircraft, for example, an aircraft turbine.

A third aspect of the invention relates to a method for mounting a guide vane ring for a turbomachine. It is provided that in one step of the method, a bearing journal of a guide vane is arranged in a form-fitting manner in a bearing bush of a bearing body. The bearing body is threaded in a guide channel running along a circumferential direction of the guide vane ring on an outer radial face of an inner ring segment, wherein at least two opposite-lying guide projections of the inner ring segment running along the circumferential direction of the guide vane ring and projecting into the guide channel are guided into at least two guide grooves of the bearing body, and the at least two guide projections of the inner ring segment are guided into a journal groove of the bearing journal of the guide vane. The inner ring segments are arranged together to form an inner ring.

The features presented in connection with the guide vane ring according to the first aspect of the invention and the turbomachine according to the second aspect of the invention as well as the advantages thereof apply correspondingly to the method according to the invention for mounting a guide vane ring according to the third aspect of the invention, and vice versa.

### BRIEF DESCRIPTION OF THE DRAWING FIGURES

Additional features of the invention result from the claims and the exemplary embodiments. The features and combinations of features named above in the description, as well as the features and combinations of features named below in the exemplary embodiments, and/or the features and combination of features shown alone can be used not only in the respectively indicated combination, but also in other combinations or alone, without departing from the scope of the invention. Thus, embodiments that are not explicitly shown and explained in the embodiment examples, but proceed from the explained embodiments and can be produced by separate combinations of features, are also to be viewed as comprised and disclosed by the invention. Embodiments and combination of features that thus do not have all features of an originally formulated independent claim are also to be viewed as disclosed. Herein:

FIG. 1 shows a schematic cross section through a guide vane ring;

FIG. 2 shows another illustration of the guide vane ring of FIG. 1;

FIG. 3 shows a schematic three-dimensional view, which represents an arrangement of the bearing body in the inner ring segment;

FIG. 4 shows the position of the guide projections of the inner ring segments in the journal groove;

FIG. 5 shows how the guide projections of the inner ring segment engage in the guide groove of the guide vane and the guide grooves of the bearing body; and

FIG. 6 shows a flow chart of a method for mounting a guide vane ring for a turbomachine.

### DESCRIPTION OF THE INVENTION

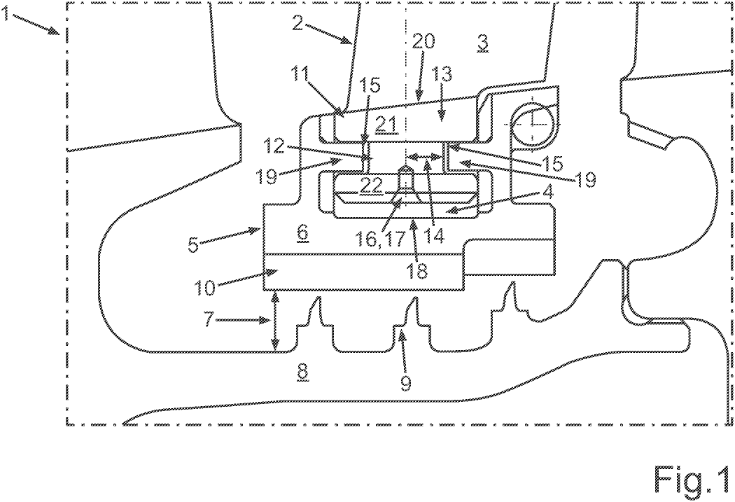

FIG. 1 shows a schematic cross section through a guide vane ring. The schematically shown guide vane ring 2 can involve the guide vane ring 2 of a turbomachine 1, wherein the turbomachine 1 can involve, in particular, a turbine of an aircraft. The guide vane ring 2 can be provided for the purpose of influencing the course of a flow of air, so that it strikes rotating blades of a rotating blade ring of the turbomachine 1 at a predetermined angle. The guide vane ring 2 can have at least one guide vane 3, which can be arranged in a bearing body 4. The bearing body 4 can be provided for the purpose of making possible a bearing of the guide vane 3 in an inner ring segment 6 of an inner ring 5 of the guide vane ring 2. The inner ring 5 of the guide vane ring 2 can be provided for the purpose of mechanically stabilizing the guide vanes 3 of the guide vane ring 2 in an inner region of the turbomachine 1. In order to minimize any efficiency loss due to leakage flow, it can be provided that a space 7 between the inner ring 5 and a rotor component 8 is sealed by an inner ring sealing means 9 and a sealing body 10 of the inner ring 5. In order, on the one hand, to prevent a reduction of the leakage flow in the space 7 as well as friction losses, which may occur due to the rubbing of the inner ring sealing means 9 against the sealing body 10, it is necessary that the space 7 remains constant during the operation of turbomachine 1. Based on so-called cording, a change in the curvature of the inner ring 5 during the operation can lead to the circumstance that the space 7 increases during the operation and thus a loss in efficiency occurs due to the greater leakage flow between the inner ring 5 and the rotor component 8. In the case when the space 7 between the inner ring 5 and the rotor component 8 decreases, losses in efficiency can also occur due to rubbing between the inner ring sealing means 9 and the sealing body 10. So-called cording can be produced, for example, by a reduction in an inner angle of the inner ring segment 6 of the inner ring 5. It is thereby possible that an inner ring can be composed of more than two inner ring segments 6. For this, however, it is necessary to make possible a more stable arrangement of the inner ring segments 6 on the guide vanes 3. The invention provides this mechanical stabilization by making possible a direct connection of the inner ring segments 6 to the guide vanes 3.

For this purpose, it can be provided that a bearing journal 11 of the guide vane 3 has a journal groove 12, which can run around the bearing journal 11. In this case, the bearing journal 11 can be configured in such a way that a journal radius 13 of the bearing journal 11 in an axial region outside the journal groove 12 is twice as large as a journal groove radius 14 within an axial region of the journal groove 12. The bearing journal 11 can be arranged in a bearing bush 20 of the bearing body 4. In order to make possible an optimal arrangement of the bearing journal 11 in the bearing body 4, the bearing body 4 can have a guide pin 16 that can engage in a bore 17 of the bearing journal 11. The bore 17 can run parallel to the axis of the bearing journal. In order to make possible an arrangement of the bearing body 4 in the inner ring segment 6, the inner ring segment 6 can have a guide channel 18, which can run along a circumferential direction around the inner ring 5 of the guide vane ring 2. Two opposite-lying guide projections 19 of the inner ring segment 6 can project into the guide channel 18. In an assembled state, the bearing body 4 with the bearing journal 11 can be arranged in the guide channel 18 in such a way that the two guide projections 19 of the inner ring segment 6 engage in both the guide grooves 15 of the bearing body 4 and in the journal groove 12 of the bearing journal 11 of the guide vane 3. In this way, a direct mechanical connection exists between the guide vane 3 and the inner ring segment 6, so that a mechanically more stable bearing of the inner ring segments 6 of the guide vanes 3 is made possible. It is possible in this way to reduce the size of the inner ring segments 6, so that the latter enclose a central point angle, for example, of 30 degrees, 45 degrees, 60 degrees, 90 degrees, or 180 degrees. By way of the journal groove 12 of the bearing journal 11, the bearing journal 11 can have two plates 21, 22, whereby these can involve an inner plate 22 and an outer plate 21. In this case, in the axial direction, the inner plate 22 can be arranged closer to the inner ring 5, whereas the outer plate 21, also in the axial direction, can be arranged closer to the guide vane 3. The plates 21, 22 can be round in order to make possible a rotation of the guide vane 3 in the bearing body 4. The bearing body 4 may contain carbon and/or metal.

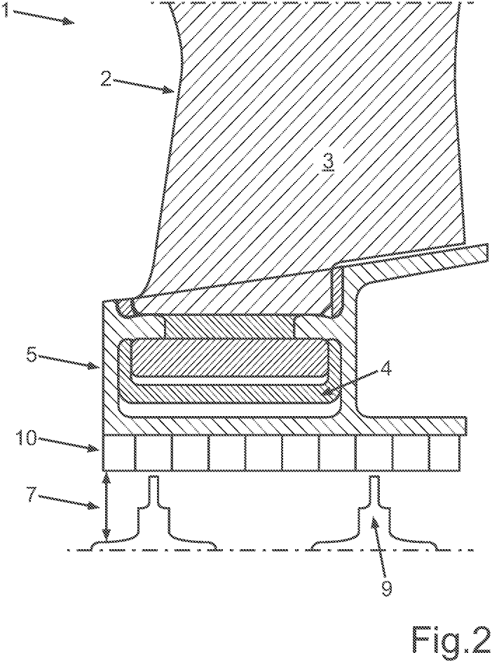

FIG. 2 shows another illustration of the guide vane ring of FIG. 1.

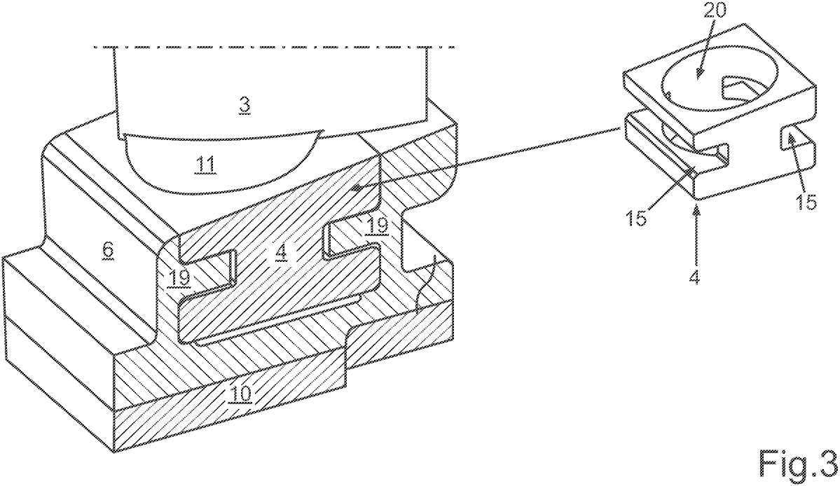

FIG. 3 shows a schematic three-dimensional view, which represents an arrangement of the bearing body in the inner ring segment;

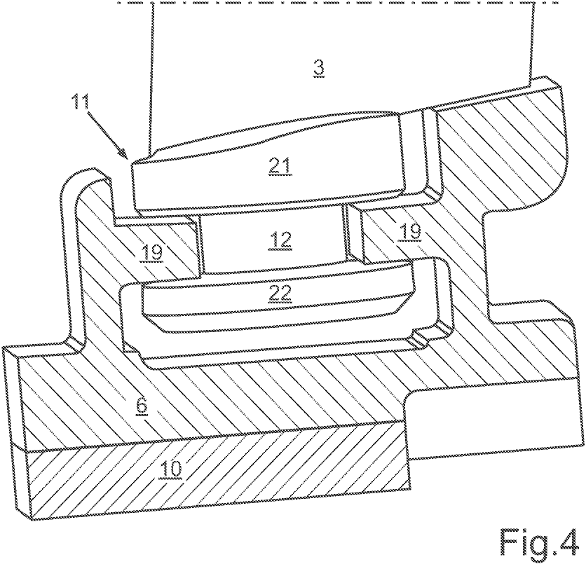

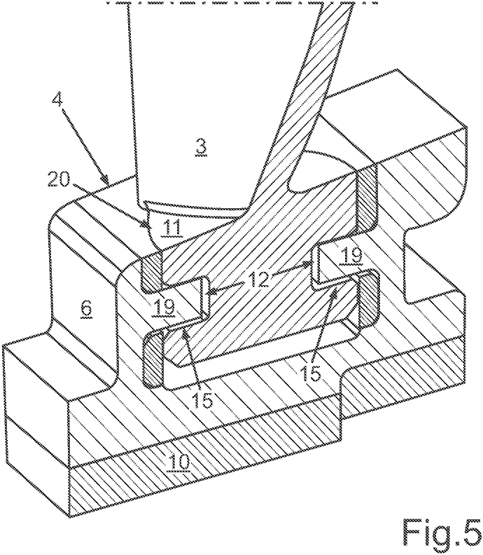

FIG. 4 shows the position of the guide projections 19 of the inner ring segments 6 in the journal groove 12, in order to make possible a bearing of the guide vane 3 in the inner ring segment 6. In FIG. 4 it can be recognized how the guide projections 19 of the inner ring segment 6 engage in the bearing body 4 at the guide grooves 15, in order to stabilize these projections in the guide channel 18. The bearing bush 20 of the bearing body 4 with a round opening can also be recognized, as seen in FIG. 5, and this makes possible a rotation of the guide vane 3.

FIG. 5 shows how the guide projections 19 of the inner ring segment 6 engage in the guide groove 12 of the bearing journal 11 of the guide vane 3 and in the guide grooves 15 of the bearing body 4, in order to fasten the guide vane 3 and the bearing body 4 in the guide channel 18.

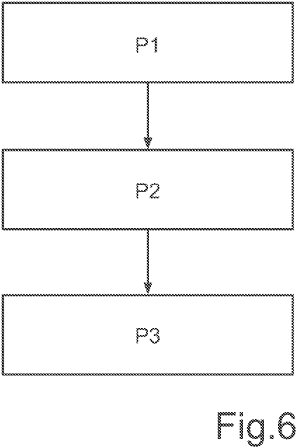

FIG. 6 shows a flow chart of a method for mounting a guide vane ring for a turbomachine. It is provided that in a first step P1 of the method, the bearing journal 11 of the guide vane 3 is arranged in a form-fitting manner in the bearing bush 20 of a bearing body 4.

In a second step P2, the bearing body 4 can be threaded in the guide channel 18 running along the circumferential direction of the guide vane ring 2 on an outer radial face of an inner ring segment 6. In this way, the at least two opposite-lying guide projections 19 of the inner ring segment 6 running along the circumferential direction of the guide vane ring 2 and projecting into the guide channel 18 can be guided into the at least two guide grooves 15 of the bearing body 4. The at least two guide projections 19 of the inner ring segment 6 can be guided at the same time into the journal groove 12 of the bearing journal 11 of the guide vane 3.

In a third step P3, the inner ring segments 6 can be arranged together to form an inner ring 5.

In the prior art, in fact, the reduction of the guide vane plate leakage as well as the possible miniaturizing of the geometry for future small compressor sizes has been achieved, but not the problem of cording, the de-curving or the overcurving of the inner ring/half ring. The cording can lead to strong gap fluctuations in the region of the separating planes of the inner ring 5. These gap fluctuations lead to a drop in efficiency when the gap is opened up due to increased leakages, or due to an overload of the shrinkability of the inner ring sealing means 9 with increased closing of the gap.

In the concept described here, the inner ring segment 6 used as a seal carrier not only joins together the bearing bodies 4 by way of the guide grooves 15, but simultaneously joins the plates 21, 22 of the guide vanes 3. This means that when the seal carrier is threaded on the bearing body 4, the guide projections 19 or hooks of the seal carrier also penetrate the journal groove 12, which was made in the plate or the bearing journal 11 of the guide vane 3. The seal carrier is thus joined radially with the bearing journal 11 of the guide vane 3 and is guided and controlled in its radial position over the guide vane 3 by the outer housing (usually by a split case). The seal carrier thus no longer absolutely needs to be a half ring, but can also be divided into smaller segments that have less cording.

1. A guide vane ring for a turbomachine comprising at least one guide vane , at least one bearing body, and at least two inner ring segments, wherein
the guide vane has a bearing journal that is arranged in a form-fitting manner in a bearing bush of the at least one bearing body;
the at least two inner ring segments have on their respective outer radial faces a guide channel running along a circumferential direction of the guide vane ring for receiving the bearing body , into which project at least two opposite-lying guide projections of the inner ring segments, said projections running along the circumferential direction of the guide vane ring;
the bearing body is arranged in the guide channel of the inner ring segments, and the at least two guide projections of the inner ring segments engage in at least two guide grooves of the bearing body or engage through these,
wherein the bearing journal of the guide vane has at least one journal groove, into which at least one of the guide projections of the inner ring segment engages.

2. The guide vane ring according to claim 1, wherein the journal groove runs around a lengthwise axis of the bearing journal.

3. The guide vane ring according to claim 2, wherein a journal groove radius of the bearing journal in the lengthwise region of the respective journal groove is at most half as large as a journal radius outside the journal groove .

4. The guide vane ring according to claim 1, wherein the bearing journal has an inner guide vane plate and an outer guide vane plate , which are separated by the journal groove.

5. The guide vane ring according to claim 2, wherein, on one axial end of the bearing journal, the bearing journal has a bore running parallel to the lengthwise axis of the bearing journal, said bore receiving a pin of the bearing body.

6. The guide vane ring according to claim 1, wherein the inner ring segments have a central point angle of 30 degrees, 45 degrees, 60 degrees, 90 degrees or 180 degrees.

7. The guide vane ring according to claim 1, wherein the bearing body is composed, at least partially, of metal and/or a carbon.

8. The guide vane ring according to claim 1, wherein sealing bodies are arranged on the inner radii of the inner ring segments.

9. A turbomachine comprising at least one guide vane ring according to claim 1.

10. A method for mounting a guide vane ring for a turbomachine according to claim 1, comprising the following steps:
arranging in a form-fitting manner a bearing journal of a guide vane in a bearing bush of a bearing body;
threading of the bearing body in a guide channel running along a circumferential direction of the guide vane ring on an outer radial face of an inner ring segment, wherein at least two opposite-lying guide projections of the inner ring segment running along the circumferential direction of the guide vane ring and projecting into the guide channel are guided into at least two guide grooves of the bearing body;
guiding the at least two guide projections of the inner ring segment into a journal groove of the bearing journal of the guide vane; and
arranging the inner ring segments together to form an inner ring.
